(19) United States
(12) Patent Application Publication
(10) Pub. No.: US 2024/0035584 A1
(43) Pub. Date: Feb. 1, 2024

(54) CHECK VALVE STRUCTURE AND METHOD OF ASSEMBLING THE SAME

(71) Applicant: MANDO CORPORATION, Gyeonggi-do (KR)

(72) Inventor: Kiwon KANG, Gyeonggi-do (KR)

(21) Appl. No.: 17/873,138

(22) Filed: Jul. 26, 2022

(51) Int. Cl. F16K 27/02; F16K 15/04; B01D 29/15; B01D 29/92

(52) U.S. Cl. CPC F16K 27/0209; F16K 15/044; B01D 29/15; B01D 29/92; B01D 2201/167

(57) ABSTRACT

Disclosed herein a check valve structure and a method of assembling the same. The check valve structure disposed in a bore of a modulator block having an inflow passage and a discharge passage to control one-way flow of oil includes a filter member configured to be press-fitted into the bore to filter foreign substances contained in oil flowing in from the inflow passage; and a valve assembly configured to be press-fitted into the bore to allow oil passing through the filter member to flow in a direction of the discharge passage; wherein the bore includes a first bore and a second bore having a diameter larger than that of the first bore, and the filter member is press-fitted into the first bore communicating with the inflow passage and the valve assembly is press-fitted into the second bore communicating with the discharge passage.

### TECHNICAL FIELD

The present disclosure relates to a check valve structure and a method of assembling the same, and more particularly, to a check valve structure disposed in a hydraulic flow path of an electronically controlled brake system to control a flow of oil in only one direction, and a method of assembling the same.

### BACKGROUND

In general, an electronically controlled brake system is a system for effectively prevent a wheel slippage that may occur during braking, sudden unintended acceleration, or rapid acceleration of a vehicle, and includes a plurality of solenoid valves that control a brake hydraulic pressure transmitted from a master cylinder to a wheel cylinder side, an accumulator for temporarily storing an oil discharged from the wheel cylinder, a pump for recovering the oil discharged from the wheel cylinder to the master cylinder side, and an electronic control unit (ECU) for controlling operation of the solenoid valves and the pump. The solenoid valves, the accumulator, and the pump are installed in a modulator block having flow paths forming a hydraulic circuit to control the brake hydraulic pressure.

On the flow paths formed in the modulator block as described above are installed check valves in order to control the flow of oil in one direction.

As is widely known, check valves are equipped with a valve housing, a ball provided in the valve housing to open and close an oil passage, a spring to elastically support the ball, and a retainer to prevent the separation of the spring. Furthermore, check valves open the oil passage according to the pressure so that the oil flows in only one direction.

However, conventional check valves do not have a filter member for filtering an oil flowing into therein, so there is a risk of entering foreign substances. For example, when foreign substances are held on a portion closing the oil passage by the ball, sealing performance is deteriorated and thus a leak may be occurred. As a result, a function of the check valves may be lost.

Furthermore, even if a filter member is provided in a check valve, the filter member may be deformed and damaged when assembling the filter member and the check valve to the modulator block.

On the other hand, when setting of a brake system, an air-bleeding operation (a work to remove air in a hydraulic circuit) is performed. In the case of a filter member being provided together with a check valve, when the filter member and the check valve are closely coupled to each other, the air-bleeding operation may not be performed efficiently.

### SUMMARY

An aspect of the disclosure is to provide a check valve structure capable of assembling a filter member together with a valve assembly to filter foreign substances flowing into a check valve, and preventing damage of the filter member during the assembling, and a method of assembling the same.

Further, an aspect of the disclosure is to provide a check valve structure capable of easily performing an air-bleeding operation when setting a brake system, and a method of assembling the same.

Additional aspects of the disclosure will be set forth in part in the description which follows and, in part, will be obvious from the description, or may be learned by practice of the disclosure.

In accordance with an aspect of the disclosure, a check valve structure disposed in a bore of a modulator block having an inflow passage and a discharge passage to control one-way flow of oil includes a filter member configured to be press-fitted into the bore to filter foreign substances contained in oil flowing in from the inflow passage; and a valve assembly configured to be press-fitted into the bore to allow oil passing through the filter member to flow in a direction of the discharge passage; and wherein the bore includes a first bore and a second bore having a diameter larger than that of the first bore, and the filter member is press-fitted into the first bore communicating with the inflow passage and the valve assembly is press-fitted into the second bore communicating with the discharge passage.

The first bore may have a length longer length than that of the filter member.

The filter member may include a body portion with a cylindrical shape having an internal flow path; and a plurality of mesh portions formed on a perimeter of the body portion, the plurality of mesh portions configured to filter foreign substances when oil flows into the internal flow path.

A plurality of support portions protruding downwardly may be provided on a lower end of the filter member.

A mesh portion may be further provided on a lower surface of the filter member to filter foreign substances when oil flows into the internal flow path.

At least one slit may be provided on a top surface of the filter member in a radial direction to be connected to the internal flow path.

The body portion may further include a press-fitting portion configured to be press-fitted into the first bore, and a frame extending from the press-fitting portion and having a plurality of through-holes into which oil flows.

The valve assembly may include a valve housing configured to be press-fitted into the second bore and having an oil passage communicating with the inflow passage and the discharge passage, a retainer coupled to the valve housing and having a discharge port communicating with the discharge passage and the oil passage, an opening/closing member provided to advance and retreat between the valve housing and the retainer to open and close the oil passage, and a spring for pressing the opening/closing member toward the oil passage.

The check valve structure may further include a cap configured to be coupled to the modulator block while sealing an opening of the bore.

The filter member may be in close contact with or spaced apart from the valve assembly by a predetermined interval.

In accordance with another aspect of the disclosure, a method of assembling a check valve structure to a bore of a modulator block having inflow and discharge passages, the bore including a first bore and a second bore having a diameter larger than that of the first bore includes the steps of: (a) press-fitting a filter member into the first bore connected to the inflow passage, and press-fitting a portion of the filter member to be positioned in the second bore; and (b) press-fitting a valve assembly into the second bore connected to the discharge passage, the valve assembly configured to allow oil from which foreign substances have been removed through the filter member to flow only in a direction of the discharge passage; wherein in the step of (b), the valve assembly is configured to be press-fitted into the second bore while press-fitting the filter member toward the first bore.

The filter member may be provided to be spaced apart from a bottom surface of the first bore after the step of (b).

The method may further include a step of installing a cap to close an opening of the bore after the step of (b).

In accordance with another aspect of the disclosure, a method of assembling a check valve structure to a bore of a modulator block having inflow and discharge passages, the bore including a first bore and a second bore having a diameter larger than that of the first bore includes the steps of: (a′) press-fitting a filter member into the first bore connected to the inflow passage so that a lower end of the filter member is in close contact with a bottom surface of the first bore; and (b′) press-fitting a valve assembly into the second bore connected to the discharge passage, the valve assembly configured to allow oil from which foreign substances have been removed through the filter member to flow only in a direction of the discharge passage; wherein the filter member has a length smaller than that of the first bore so that the filter member and the valve assembly are provided to be spaced apart from each other.

The method may further include a step of installing a cap to close an opening of the bore after the step of (b).

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a cross-sectional view illustrating a check valve structure according to an exemplary embodiment of the present disclosure;

FIG. 2 is a perspective view illustrating a filter member provided in a check valve structure according to an exemplary embodiment of the present disclosure;

FIG. 3 is a view illustrating an operating state of a check valve structure according to an exemplary embodiment of the present disclosure;

FIG. 4 is a view illustrating a state in which a check valve structure according to an exemplary embodiment of the present disclosure is assembled to a modulator block;

FIG. 5 is a view illustrating another embodiment state in which a check valve structure according to an exemplary embodiment of the present disclosure is assembled to a modulator block; and

FIG. 6 is a view illustrating another embodiment state in which a check valve structure according to an exemplary embodiment of the present disclosure is assembled to a modulator block.

### DETAILED DESCRIPTION

Hereinafter, the embodiments of the disclosure will be described in detail with reference to accompanying drawings. It should be understood that the terms used in the specification and the appended claims should not be construed as limited to general and dictionary meanings, but interpreted based on the meanings and concepts corresponding to technical aspects of the disclosure on the basis of the principle that the inventor is allowed to define terms appropriately for the best explanation. Therefore, the description proposed herein is just a preferable example for the purpose of illustrations only, not intended to limit the scope of the disclosure, so it should be understood that other equivalents and modifications could be made thereto without departing from the spirit and scope of the disclosure.

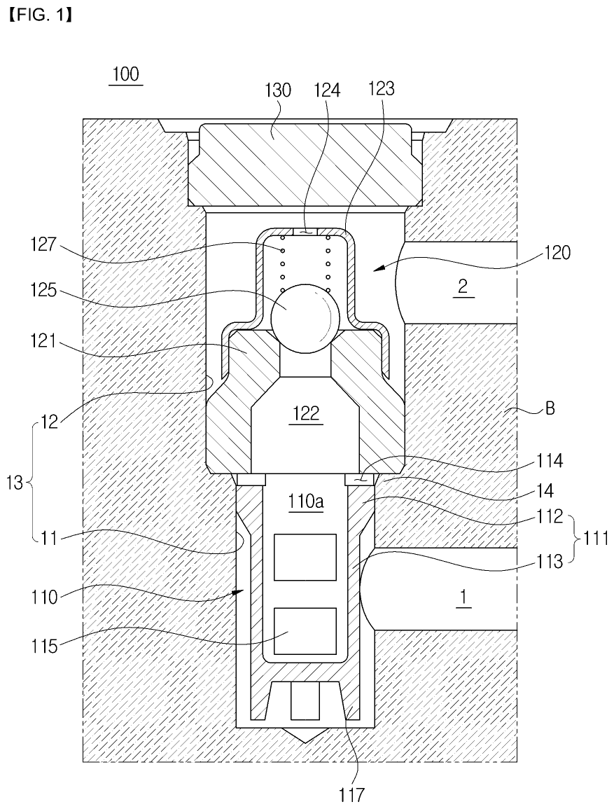

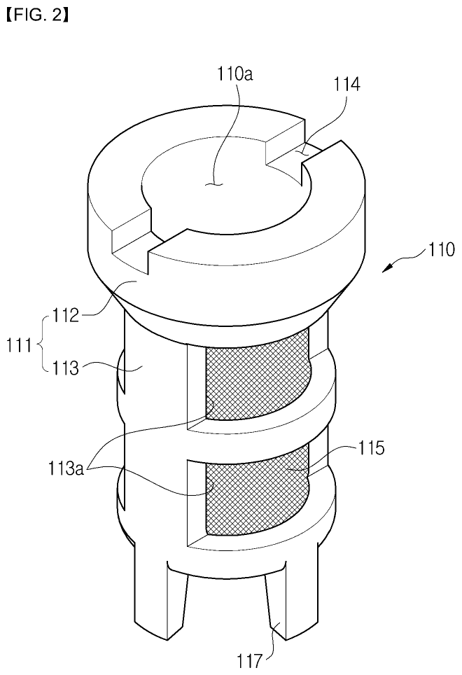

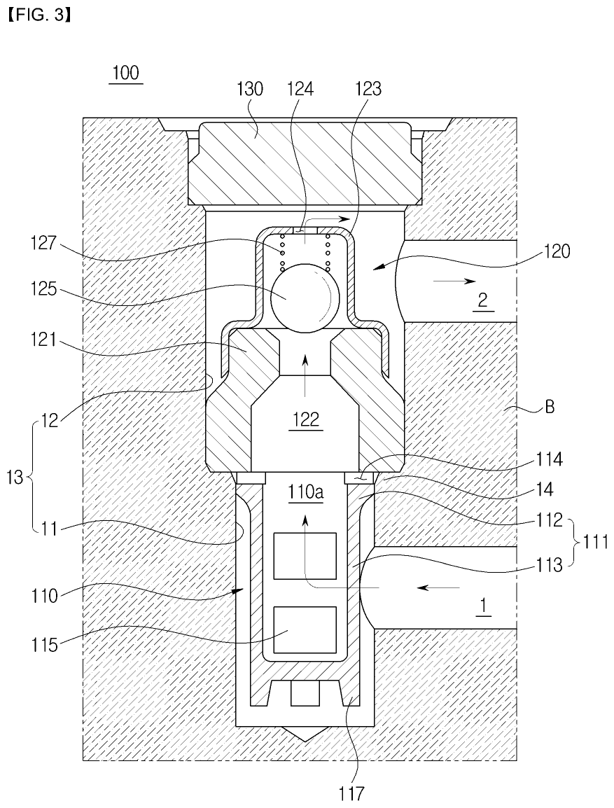

FIG. 1 is a cross-sectional view illustrating a check valve structure according to an exemplary embodiment of the present disclosure, FIG. 2 is a perspective view illustrating a filter member provided in a check valve structure according to an exemplary embodiment of the present disclosure, and FIG. 3 is a view illustrating an operating state of a check valve structure according to an exemplary embodiment of the present disclosure;

Referring to FIGS. 1 to 3, a check valve structure 100 includes a filter member 110, a valve assembly 120, and a cap 130. The check valve structure 100 is installed in a bore 13, which is connected to an inflow passage 1 and a discharge passage 2 formed in a modulator block B, to prevent a reverse flow of oil and to open and close according to pressure to allow the oil to flow in one direction. At this time, the valve assembly 120 of the check valve structure 100 is mounted in the bore 13 in the form of an assembly assembled from the outside, and the cap 130 closing the bore 13 is separated from the valve assembly 120 and separately mounted to close the bore 13.

As shown the drawings, the bore 13 is formed by machining the modulator block B. The bore 13 has one end open and is formed to be stepped to support the valve assembly 120 to be described later. In other words, the bore 13 includes a first bore 11 having a small diameter portion stepped by a step portion 14 and a second bore 12 having a relatively larger diameter than that of the first bore 11. At this time, the step portion 14 supports a lower end of the valve assembly 120 to be described later, and serves as a reference point for a region dividing the first and second bores 11 and 12. Furthermore, the first bore 11 communicates with the inflow passage 1, and the second bore 12 communicates with the discharge passage 2.

The filter member 110 is press-fitted to the first bore 11 and serves to filter foreign substances contained in the oil flowing in from the inflow passage 1. In this case, the filter member 110 may be provided to have a length shorter than that of the first bore 11. The difference in length between the filter member 110 and the first bore 11 will be described again below.

The filter member 110 may include a body portion 111 with cylindrical shape having an internal flow path 110a, a mesh portion 115 provided to filter foreign substances when oil flows into the internal flow path 110a, and a plurality of support portions 117 protruding from a lower end of the body portion 111.

The body portion 111 may include a press-fitting portion 112 press-fitted into the first bore 11, and a frame 113 extending from the press-fitting portion 112. In other words, the press-fitting portion 112 may be provided to have the same diameter as that of the first bore 11. Furthermore, the frame 113 may be formed to have a plurality of through-holes 113a so that oil flows smoothly into the internal flow path 110a. In this case, the diameter of the frame 113 may be provided to have a smaller than that of the press-fitting portion 112. That is, an annular space may be formed between the first bore 11 and the frame 113. This is to allow the oil flowing in from the inflow passage 1 to smoothly flow into the internal flow path 110a through the through-holes 113a.

The mesh portion 115 serves to remove foreign substances contained in oil, and may be installed in the frame 113 as a whole, but may be provided only in a portion in which the through-holes 113a is formed.

Furthermore, at least one slit 114 formed in a radial direction to be connected to the internal flow path 110a may be provided on a top surface of the filter member 110, that is, a top surface of the body portion 111. When initially setting a brake system an air bleeding operation is performed, and at this time, the at least one slit 114 may smoothly remove the air inside the check valve structure 100 installed in the bore 13. As shown in FIG. 1, the filter member 110 and the valve assembly 120 are assembled to be in close contact with each other. Accordingly, a problem that air is trapped between the filter member 110 and the valve assembly 120 during the air bleeding operation and is not smoothly discharged may be occurred, but the check valve structure 100 according to an embodiment of the disclosure is provided in the slit 114, thereby allowing the air to be discharged smoothly.

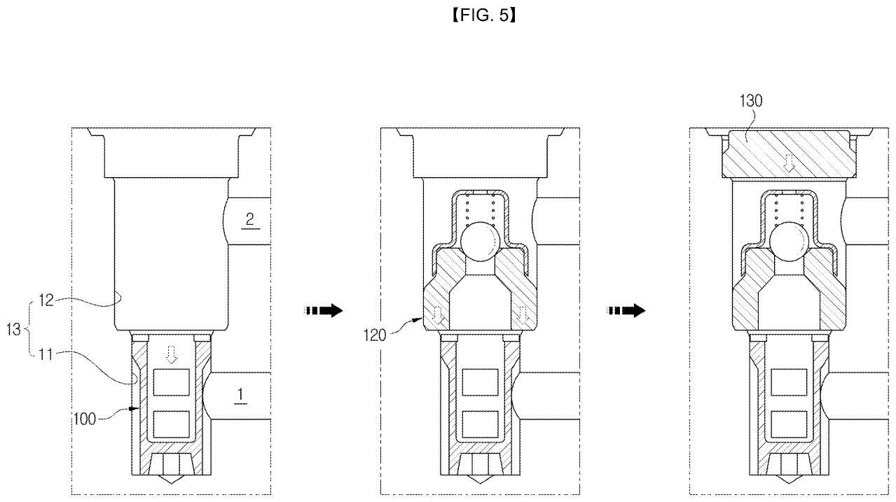

On the other hand, the filter member 110 is shown and described as that oil flows in through the plurality of through-holes 113a and the mesh portion 115, which are formed on a perimeter of the body portion 111, but is not limited thereto. For example, the oil may flow in through the lower surface of the body portion 111. FIG. 5 shows a filter member according to another exemplary embodiment of the present disclosure. Here, like reference numerals as in the drawings shown above refer to members having the same function.

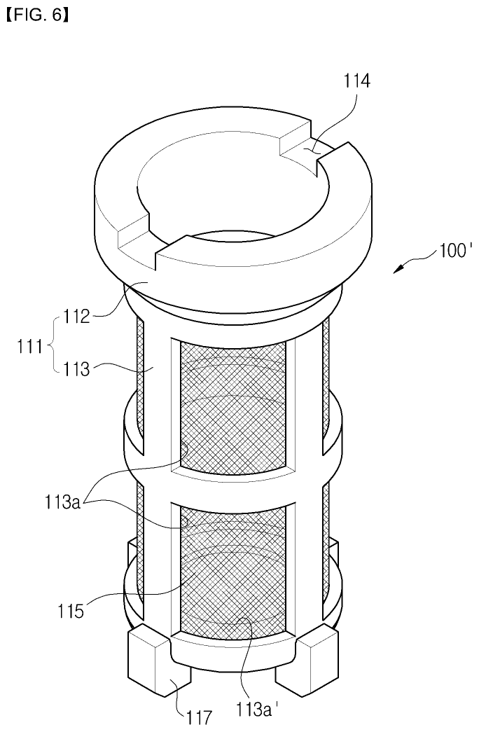

Referring to FIG. 6, a filter member 110′ has the internal flow path 110a, and includes the cylindrical body portion 111 including the press-fitting portion 112 and the frame 113, the mesh portion 115 provided to filter foreign substances when oil flows into the internal flow path 110a, and the plurality of support portions 117 protruding from the lower end of the body portion 111. In addition, the mesh portion 115 may be provided to filter foreign substances introduced through the through-holes 113a formed in the lower surface of the body portion 111. In other words, the filter member 110 according to the embodiment further includes a through-hole 113a′ formed at a lower end of the frame 113 and the mesh portion 115 covering the through-hole 113a′, which is different from the filter member 110 of the previous embodiment. Accordingly, oil may be introduced into the internal flow path 110a through the lower surface as well as in the circumferential direction of the body portion 111.

The filter members 110 and 110′ as described above may be provided to be in close contact with the valve assembly 120 to be described later or to be spaced apart from each other by a predetermined interval. This is because the length of the first bore 11 is longer than that of the filter members 110 and 110′. In other words, if the length of the filter members 110 and 110′ is longer than that of the first bore 11, the filter members 110 and 110′ may be damaged or deformed by being pressed during assembly of the valve assembly 120. A structure in which the filter members 110 and 110′ are installed to be in close contact with the valve assembly 120 or be spaced apart from each other by a predetermined interval will be described again below.

Referring back to FIGS. 1 to 3, the valve assembly 120 includes a valve housing 121, a retainer 123, an opening/closing member 125, and a spring 127. The valve assembly 120 is press-fitted to the second bore 12 to prevent the reverse flow of oil and control the oil to flow only through the discharge passage 2.

The valve housing 121 is penetrated so that both upper and lower ends thereof are opened to form an oil passage 122 communicating with the inflow passage 1 and the discharge passage 2. The valve housing 121 has a stepped shape so that the retainer 123 to be described later is coupled thereto, and is press-fitted to the second bore 12. At this time, the valve housing 121 may be press-fitted the second bore 12 so that the lower end thereof is supported by the step portion 14.

The retainer 123 is coupled to a portion discharged through the oil passage 122 of the valve housing 110 to support the spring 127. As shown in the drawings, the retainer 123 is coupled to an upper side of the valve housing 121. The retainer 123 is provided with a discharge port 124 communicating with the discharge passage 2. Furthermore, the retainer 123 may be bent to support an upper end of the spring 127 that elastically presses the opening/closing member 125, and may be coupled to surround an outer circumferential surface of the upper end side of the valve housing 121.

The opening/closing member 125 is provided to be movable in a vertical direction within the valve housing 121 and the retainer 123, and is normally elastically supported by the spring 127 to close the oil passage 122. In other words, the opening/closing member 125 compresses the spring 127 by the pressure of the oil introduced through the filter member 110 to open the oil passage 122. Accordingly, the oil is discharged to the discharge passage 2 through the discharge port 124 and the second bore 12. Furthermore, when the pressure of the oil becomes smaller than elastic force of the spring 127, the opening/closing member 125 closes the oil passage 122 to prevent the oil from flowing back.

When the filter member 110 and the valve assembly 120 are assembled to the first and second bores 11 and 12, respectively, the cap 130 is coupled to the modulator block B to seal an opening of the bore 13.

On the other hand, although this embodiment is illustrated that the inflow passage 1 and the discharge passage 2 are formed in a lateral direction with respect to the bore 13, the present disclosure is not limited thereto, and may be formed in a longitudinal direction with respect to the bore 13. In the case of the discharge passage 2 being formed in the longitudinal direction, the cap is unnecessary. Furthermore, even if the inflow passage 1 and the discharge passage 2 are formed in the longitudinal direction, the function of preventing foreign substances from being introduced into the valve assembly 120 by the filter member 110 may be smoothly performed.

Then, a method of assembling the check valve structure having the above structure to the bore of the modulator block will be described.

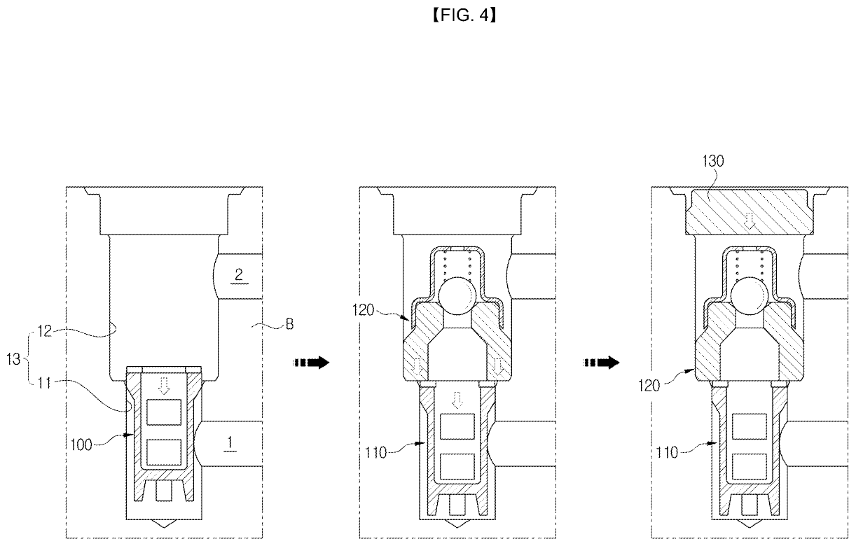

Referring to FIG. 4, the filter member 110 is press-fitted into the first bore 11 connected to the inflow passage 1. In this case, the filter member 110 may be assembled such that the upper end thereof is positioned in the second bore 12 based on the step portion 14 that divides the first bore 11 and the second bore 12.

Next, the valve assembly 120 is press-fitted into the second bore 12 connected to the discharge passage 2. At this time, the valve assembly 120 is press-fitted to the second bore 12 while pressing the filter member 110 toward the first bore 11. In other words, the filter member 110 is press-fitted and fixed to the first bore 11 by the valve assembly 120, and the lower end of the valve assembly 120 is supported by the step portion 14, thereby completing the press-fitting.

At this time, because the filter member 110 is provided to have a length shorter length than that of the first bore 11, the support portion 117 provided at the lower end of the filter member 110 is spaced apart from the bottom surface of the first bore 11 by a predetermined interval. Accordingly, it is possible to prevent the filter member 110 from being excessively pressed and deformed or damaged.

Furthermore, even if the upper surface of the filter member 110 and the lower surface of the valve assembly 120 are provided in a contact state, the slit 114 formed at the upper end of the filter member 110 allows the air inside the check valve structure 100 to be smoothly discharged to the outside during the air bleeding operation.

On the other hand, the valve assembly 120 is provided as one assembly in which the valve housing 121, the retainer 123, the opening/closing member 125, and the spring 127 are assembled. Accordingly, the valve assembly 120 may be assembled to the second bore 12 through one assembly process.

Finally, the opening of the bore 13 is closed through the cap 130 after the filter member 110 and the valve assembly 120 are press-fitted thereto.

As another exemplary embodiment of assembling the check valve structure 100 of the present disclosure to the bore 13, an assembling method for removing foreign substances of oil flowing in through the filter member 110 and preventing deformation and damage of the filter member 110 will be described with reference to FIG. 5.

First, the filter member 110 is press-fitted into the first bore 11 connected to the inflow passage 1. In this case, the filter member 110 may be assembled such that the supports 117 provided at the lower end thereof is in contact with the bottom surface of the first bore 11. The filter member 110 is provided to have a length shorter than that of the first bore 11, the top surface of the filter member 110 is positioned on the lower side of the step portion 14 dividing the first bore 11 and the second bore 12.

Next, the valve assembly 120 is press-fitted into the second bore 12 connected to the discharge passage 2. The lower end of the valve assembly 120 is supported by the step portion 14, so that press-fitting is completed. In other words, the assembly of the valve assembly 120 and the filter member 110 is completed in a state in which they are spaced apart from each other by a predetermined interval. Accordingly, the filter member 110 is prevented from being unnecessarily pressed by the valve assembly 120, thereby preventing deformation or damage.

Furthermore, because the upper surface of the filter member 110 and the lower surface of the valve assembly 120 are spaced apart from each other, so that air in the check valve structure 100 may be smoothly discharged during the air bleeding operation.

On the other hand, the valve assembly 120 is provided as one assembly in which the valve housing 121, the retainer 123, the opening/closing member 125, and the spring 127 are assembled. Accordingly, the valve assembly 120 may be assembled to the second bore 12 through one assembly process.

Finally, the opening of the bore 13 is closed through the cap 130 after the filter member 110 and the valve assembly 120 are press-fitted thereto.

As is apparent from the above, a check valve structure according to an exemplary embodiment of the present disclosure may filter foreign substances flowing into the check valve by assembling the filter member together with the valve assembly, thereby preventing deterioration of the function of the check valve as well as damage of the filter member, and a method of assembling the same.

Furthermore, a check valve structure according to an exemplary embodiment of the present disclosure may have effect of easily performing an air-bleeding operation when a brake system is set, and a method of assembling the same.

As described above, the exemplary embodiments of the disclosure have thus far been described with reference to accompanying drawings. It will be obvious to those of ordinary skill in the art that the disclosure may be practiced in other forms than the exemplary embodiments as described above without changing the technical idea or essential features of the disclosure. The above exemplary embodiments are only by way of example, and should not be interpreted in a limited sense.

What is claimed is:

1. A check valve structure disposed in a bore of a modulator block having an inflow passage and a discharge passage to control one-way flow of oil, comprising:
a filter member configured to be press-fitted into the bore to filter foreign substances contained in oil flowing in from the inflow passage; and
a valve assembly configured to be press-fitted into the bore to allow oil passing through the filter member to flow in a direction of the discharge passage;
wherein the bore includes a first bore and a second bore having a diameter larger than that of the first bore, and
the filter member is press-fitted into the first bore communicating with the inflow passage and the valve assembly is press-fitted into the second bore communicating with the discharge passage.

2. The check valve structure of claim 1, wherein the first bore has a length longer length than that of the filter member.

3. The check valve structure of claim 1, wherein the filter member comprises:
a body portion with a cylindrical shape having an internal flow path; and
a plurality of mesh portions formed on a perimeter of the body portion, the plurality of mesh portions configured to filter foreign substances when oil flows into the internal flow path.

4. The check valve structure of claim 3, wherein a plurality of support portions protruding downwardly are provided on a lower end of the filter member.

5. The check valve structure of claim 3, wherein a mesh portion is further provided on a lower surface of the filter member to filter foreign substances when oil flows into the internal flow path.

6. The check valve structure of claim 3, wherein at least one slit is provided on a top surface of the filter member in a radial direction to be connected to the internal flow path.

7. The check valve structure of claim 3, wherein the body portion further comprises:
a press-fitting portion configured to be press-fitted into the first bore, and
a frame extending from the press-fitting portion and having a plurality of through-holes into which oil flows.

8. The check valve structure of claim 1, wherein the valve assembly comprises:
a valve housing configured to be press-fitted into the second bore and having an oil passage communicating with the inflow passage and the discharge passage,
a retainer coupled to the valve housing and having a discharge port communicating with the discharge passage and the oil passage,
an opening/closing member provided to advance and retreat between the valve housing and the retainer to open and close the oil passage, and
a spring for pressing the opening/closing member toward the oil passage.

9. The check valve structure of claim 1, further comprising a cap configured to be coupled to the modulator block while sealing an opening of the bore.

10. The check valve structure of claim 1, wherein the filter member is configured to be in close contact with or spaced apart from the valve assembly by a predetermined interval.

11. A method of assembling a check valve structure to a bore of a modulator block having inflow and discharge passages, the bore including a first bore and a second bore having a diameter larger than that of the first bore, the method comprising the steps of:
(a) press-fitting a filter member into the first bore connected to the inflow passage, and press-fitting a portion of the filter member to be positioned in the second bore; and
(b) press-fitting a valve assembly into the second bore connected to the discharge passage, the valve assembly configured to allow oil from which foreign substances have been removed through the filter member to flow only in a direction of the discharge passage;
wherein in the step of (b), the valve assembly is configured to be press-fitted into the second bore while press-fitting the filter member toward the first bore.

12. The method of claim 11, wherein the filter member is provided to be spaced apart from a bottom surface of the first bore after the step of (b).

13. The method of claim 11, further comprising a step of installing a cap to close an opening of the bore after the step of (b).

14. A method of assembling a check valve structure to a bore of a modulator block having inflow and discharge passages, the bore including a first bore and a second bore having a diameter larger than that of the first bore, the method comprising the steps of:
(a′) press-fitting a filter member into the first bore connected to the inflow passage so that a lower end of the filter member is in close contact with a bottom surface of the first bore; and
(b′) press-fitting a valve assembly into the second bore connected to the discharge passage, the valve assembly configured to allow oil from which foreign substances have been removed through the filter member to flow only in a direction of the discharge passage;
wherein the filter member has a length smaller than that of the first bore so that the filter member and the valve assembly are provided to be spaced apart from each other.

15. The method of claim 14, further comprising a step of installing a cap to close an opening of the bore after the step of (b).
